(19) United States
(12) Patent Application Publication
(10) Pub. No.: US 2012/0306466 A1
(43) Pub. Date: Dec. 6, 2012

(54) STEP-UP DC-DC CONVERTER

(75) Inventors: Hitoshi Tabuchi, Isehara-shi (JP); Takashi Hiroshima, Atsugi-shi (JP)

(73) Assignee: MITSUMI ELECTRIC CO., LTD, Tama-shi (JP)

(21) Appl. No.: 13/487,861

(22) Filed: Jun. 4, 2012

(30) Foreign Application Priority Data
Jun. 6, 2011 (JP) 2011-125906

(51) Int. Cl. G05F 1/10

(52) U.S. Cl. 323/282

(57) ABSTRACT

A step-up DC-DC converter has a switching element for feeding current to an inductor; a rectifier connected to the output side of the inductor; and a control circuit performing on/off control of the switching element, based on an output voltage and a voltage corresponded to the inductor current. The control circuit further has a first voltage comparator circuit detecting fall of the output voltage down to the first reference voltage; a second voltage comparator circuit detecting that the inductor current reached a predetermined current value; and a voltage generation circuit generating a voltage inversely proportional to an input voltage and feeds the voltage, as a second reference voltage, to the second voltage comparator circuit. The switching element turns on, when the output voltage fell down to the first reference voltage, whereas the switching element turns off, when voltage proportional to the inductor current rose up to the second reference voltage.

### CROSS-REFERENCE TO RELATED APPLICATION

The present U.S. patent application claims a priority under the Paris Convention of Japanese patent application No. 2011-125906 filed on Jun. 6, 2011 which shall be a basis of correction of an incorrect translation, and is incorporated by reference herein.

### BACKGROUND OF THE INVENTION

1. Field of the Invention

The present invention relates to a step-up power supply used for DC voltage conversion, based on the switching regulator system, and in particular to a step-up DC-DC converter which controls output based on the PFM (pulse frequency modulation) system.

2. Description of Related Art

DC-DC converters based on the switching regulator system have been known as a sort of circuit capable of converting DC input voltage and outputting a converted DC voltage having a different potential. The DC-DC converters are classified into those of step-up type and step-down type. The DC-DC converter has a drive switching element; a rectifier; and a control circuit. The drive switching element applies DC voltage, fed by a DC power source such as a battery, to an inductor (coil) so as to allow current to flow therethrough, to thereby store energy in the coil. The rectifier rectifies the coil current in a period of energy discharge after the drive switching element turns off. The control circuit performs on/off control of the drive switching element.

In the conventional DC-DC converter based on the switching regulator system, the control is implemented by a feedback operation by which voltage proportional to the output voltage is fed back to a comparator for PFM (pulse frequency modulation) control, or to a comparator for PWM (pulse width modulation) control. When the output voltage falls, the frequency or pulse width is controlled so as to elongate the ON time of the drive switching element, whereas when the output voltage rises, the frequency or pulse width is controlled so as to shorten the ON time of the drive switching element (see Japanese Laid-Open Patent Publication No. 2005-218167, for example).

FIG. 4 illustrates an exemplary configuration of a conventional step-up DC-DC converter based on the PFM control system, and FIG. 5 illustrates a timing chart of the conventional PFM control system. As seen in FIG. 4, the step-up DC-DC converter based on the PFM control system has an output voltage detection comparator CMP1, a current limiting comparator CMP2, and a reverse current detection comparator CMP3. The output voltage detection comparator CMP1 compares output voltage Vout and a predetermined reference voltage Vref1. The current limiting comparator CMP2 compares output-side voltage Vsw of an inductor (coil) L1 and reference voltage Vref2. The reverse current detection comparator CMP3 compares the output voltage Vout and the output-side voltage Vsw of the inductor (coil) L1, to detect a state of reverse current.

In the step-up DC-DC converter illustrated in FIG. 4, when the output voltage Vout falls below the reference voltage Vref1 as a result of discharge of output current Iout, the output of the output voltage detection comparator CMP1 becomes high and sets an RS flipflop FF1, and output Q of the RS flipflop FF1 becomes high so as to turn the switching element M1 on. When the switching element M1 turns on, inductor current IL increases with a slope of Vin/L (Vin represents an input voltage, and L represents an inductance value of the inductor L1), and voltage Vsw at a connection node SW of the inductor L1 and the switching element M1 elevates. When the voltage Vsw exceeds the reference voltage Vref2, the output of the current limiting comparator CMP2 becomes high, the output of the current limiting comparator CMP2 sets the RS flipflop FF2, the output Q of the RS flip-flop FF2 becomes high to thereby reset the flipflop FF1, and the output Q of the flipflop FF1 becomes low to thereby turn the switching element M1 off and turn the rectifying switching element M2 on. A current value of the inductor current IL is now denoted as Imax.

When the rectifying switching element M2 turns on, the inductor current IL decreases with a slope of (Vout−Vin)/L. Moreover, when the rectifying switching element M2 turns on, electric power is fed to an output terminal OUT, to thereby increase the output voltage Vout. When the inductor current IL decreases thereafter to attain Vout>Vsw, the output of the reverse current detection comparator CMP3 becomes high, to thereby reset the flipflop FF2. Thereafter, the rectifying switching element M2 turns off.

By repeating the above-described operations, the step-up DC-DC converter based on the PFM control outputs the output voltage Vout at a predetermined level. In the step-up DC-DC converter based on the PFM control, an output ripple voltage ΔVp−p is given by the equation below:

ΔVp−p=(Imax²×L)÷(2×Cout×(Vout−Vin)) formula (1)

where, Imax is current limit value of the inductor current IL, Cout is capacitance of an output capacitor C0, Vout output voltage value, and Vin is input voltage value.

It is known from the formula (1) that, in the conventional DC-DC converter, when the input voltage Vin increases, the ΔVp−p increases as a consequence. Referring now to the timing chart in FIG. 5, at points of time t1, t2 the input voltage Vin rises up, decrease in the inductor current IL is moderated, and thereby detection of reverse current delays. As a result of elongation of the ON times T1, T2 of the switching element M2, the output voltage Vout becomes high, and this elongates the time from turning off of the switching element M2 to turning on of the switching element M1 after the output voltage Vout falls down to the reference voltage Vref1. Accordingly, the output ripple voltage ΔVp−p increases. Increase in ΔVp−p has unfortunately resulted in humming of the inductor or the output capacitor, and malfunction of devices.

Given that the maximum output current value possibly output by the DC-DC converter is Iout(MAX), this is given by the equation below:

Iout(MAX)=Vin×Imax×η)±(2×Vout) formula (2)

where, η is an efficiency of power conversion by the DC-DC converter.

Accordingly, the ripple voltage ΔVp−p may be reduced by lowering Imax. Note however that, since the maximum output current value Iout(MAX) is determined by the value of Imax, so that it is necessary to set Imax depending on a desired level of Iout(MAX). It is, therefore, not possible to simply reduce Imax irrespective of Iout(MAX). It is also understood from the formula (1) that the ripple voltage may be reduced also by increasing the capacitance of the output capacitor C0 or by reducing the inductance of the inductor L1. It is, however, not always possible to modify the values of the output capacitor C0 or the inductor L1, because of characteristics required for the DC-DC converter.

### SUMMARY OF THE INVENTION

The present invention was conceived in consideration of the situation described in the above, and an object of which is to provide a step-up DC-DC converter based on the PFM control system, capable of reducing the ripple voltage of output while achieving a desired level of maximum output current value Iout(MAX), while successfully preventing the humming or malfunction, without modifying external components (L1, C0).

For the purpose of attaining the above-described objects, according to one embodiment of the present invention, there is provided a step-up DC-DC converter including: a voltage input terminal through which DC input voltage is input; a voltage output terminal through which an output voltage stepped up from the input voltage is output; an inductor having an input-side terminal connected to the voltage input terminal; a drive switching element connected to an output-side terminal of the inductor; a rectifier connected between the output-side terminal of the inductor and the voltage output terminal; and a control circuit which generates a drive pulse used for ON/OFF control of the drive switching element, based on a feedback voltage received from the voltage output terminal and a voltage proportional to current flowing through the inductor. The control circuit further includes: a first voltage comparator circuit which compares the feedback voltage received through the voltage output terminal, with a predetermined first reference voltage, and detects fall of the feedback voltage down to the first reference voltage; a second voltage comparator circuit which compares a voltage proportional to current flowing through the inductor, with a second reference voltage, and detects rise of the voltage proportional to current flowing through the inductor up to the second reference voltage; and a voltage generation circuit which generates a voltage inversely proportional to the input voltage and feeds the voltage, as the second reference voltage, to the second voltage comparator circuit. The step-up DC-DC converter is configured so that: the drive switching element turns on when the first voltage comparator circuit detects that the feedback voltage fell down to the first reference voltage, and the drive switching element turns off when the second voltage comparator circuit detects that the voltage proportional to current flowing through the inductor rose up to the second reference voltage.

### BRIEF DESCRIPTION OF THE DRAWINGS

The above objects, advantages and features of the present invention will become more fully understood from the detailed description given hereinbelow and the appended drawings which are given by way of illustration only, and thus are not intended as a definition of the limits of the present invention, and wherein:

FIG. 1 is a circuit configuration diagram illustrating one embodiment of the step-up DC-DC converter, based on the PFM control system, of one embodiment of the present invention;

FIG. 2 is a timing chart illustrating operations of the DC-DC converter of the embodiment, under varied input voltage;

FIG. 3 is a circuit configuration diagram illustrating a modified example of the DC-DC converter of the embodiment;

FIG. 4 is a circuit configuration diagram illustrating a conventional step-up DC-DC converter based on the PFM control system: and

FIG. 5 is a timing chart illustrating operations of the conventional DC-DC converter, under varied input voltage.

### DESCRIPTION OF PREFERRED EMBODIMENTS

Preferred embodiments of the present invention will be explained below, referring to the attached drawings.

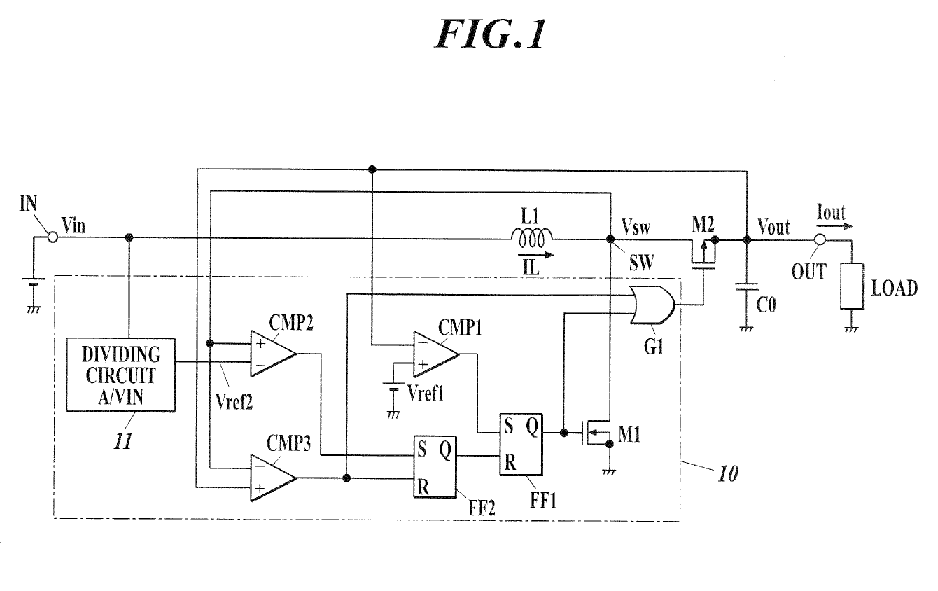

FIG. 1 is a drawing illustrating one embodiment of the step-up DC-DC converter, based on the PFM (pulse frequency modulation) system for output control, of the present invention.

The DC-DC converter of this embodiment has a coil L1, a drive switching element M1, a rectifying switching element M2, a switching control circuit 10, and an output smoothing capacitor C0. The coil L1 is an inductor having one terminal thereof connected to an voltage input terminal IN through which DC input voltage Vin is applied. The drive switching element M1 is connected between the other terminal of the coil L1 and a grounding point. An N-channel MOSFET (insulated-gate field effect transistor) may be used as the drive switching element M1. The rectifying switching element M2 is connected between a connection node (terminal SW) of the coil L1 and the switching element M1, and an output terminal OUT. A P-channel MOSFET may be used as the rectifying switching element M2.

The switching control circuit 10 performs on/off control of the switching elements M1, M2. The output smoothing capacitor C0 is connected between the output terminal OUT and the grounding point.

Although not specifically limited, of the circuit and elements which compose the DC-DC converter, the switching control circuit 10 and the switching elements M1, M2 may be formed on a semiconductor chip, and thereby given in a form of semiconductor integrated circuit (power supply control IC), wherein the coil L1 and the capacitor C0 may be connected, as external elements, to external terminals provided to the IC.

In the DC-DC converter of this embodiment, a drive pulse which alternately turning on or off the switching elements M1 and M2 is generated by the switching control circuit 10. When the drive switching element M1 turns on, current flows through the coil L1 to the grounding point, and thereby energy is stored in the coil L1.

When the drive switching element M1 turns off thereafter, the rectifying switching element M2 turns on, the energy having been stored in the coil L1 is released, thereby current flows through the rectifying switching element M2 towards the output terminal OUT, and the capacitor C0 is charged. By repeating the operations described in the above, DC output voltage Vout having a predetermined potential, stepped up from the DC input voltage Vin, is generated.

The switching control circuit 10 has the output voltage detection comparator CMP1, the current limiting comparator CMP2, the reverse current detection comparator CMP3, an RS flip-flop FF1, an RS flipflop FF2, an OR gate G1, and a reference voltage generation circuit 11.

The output voltage detection comparator CMP1 receives, as input signals, the output voltage Vout and a predetermined reference voltage Vref1, and detects that the output voltage Vout fell down to the reference voltage Vref1. Note that the output voltage detection comparator CMP1 may alternatively compare voltage obtained by dividing the output voltage Vout, in place of using the whole output voltage Vout, with the reference voltage Vref1.

The current limiting comparator CMP2 compares the output-side voltage Vsw of the inductor (coil) L1 and a predetermined reference voltage Vref2. The reverse current detection comparator CMP3 compares the output voltage Vout and the output-side voltage Vsw of the inductor (coil) L1, and detects a reverse current state.

The RS flipflop FF1 receives an output signal for controlling the output voltage detection comparator CMP1 through the set terminal, and outputs a gate control signal of the drive switching element M1. The RS flipflop FF2 receives an output signal of the current limiting comparator CMP2 through the set terminal, and also receives an output signal of the reverse current detection comparator CMP3 through the reset terminal. An output signal of the RS flipflop FF2 is fed to the reset terminal of the RS flipflop FF1. The OR gate G1 receives, as input signals, an output signal of the reverse current detection comparator CMP3 and an output signal of the RS flipflop FF1, and outputs a gate control signal of the rectifying switching element M2. Accordingly, the rectifying switching element M2 may be turned off in a well-timed manner.

The reference voltage generation circuit 11 generates a voltage inversely proportional to the input voltage Vin, based on the input voltage Vin. The voltage inversely proportional to the input voltage Vin is fed, as the reference voltage Vref2, to the inverted input terminal of the current limiting comparator CMP2. The reference voltage generation circuit 11 may be configured by a publicly-known dividing circuit which typically uses an operational amplifier circuit. By using a publicly-known dividing circuit for the reference voltage generation circuit 11, work load on the designer may be reduced.

While FIG. 1 illustrates an exemplary case where the output voltage of the RS flipflop FF1 is directly used for turning the switching element M1 on or off, it is more common to provide a driver circuit between the RS flipflop FF1 and the switching element M1, so as to allow the driver circuit, which is driven by an output signal of the RS flipflop FF1, to drive the switching element M1. The same will apply also to the switching element M2.

Next, operations of the DC-DC converter of the embodiment, having the switching control circuit 10 will be explained.

In the step-up DC-DC converter illustrated in FIG. 1, when the output voltage Vout falls below the reference voltage Vref1 as a result of discharge of the output current Iout, the output of the voltage detection comparator CMP1 becomes high and sets the RS flipflop FF1, the output Q of the RS flipflop FF1 becomes high, and thereby the drive switching element M1 turns on. When the drive switching element M1 turns on, the inductor current IL increases with a slope of Vin/L (where, Vin is input voltage, and L is inductance of the inductor L1), and thereby voltage Vsw at the connection node SW of the inductor L1 and the drive switching element M1 elevates.

When the voltage Vsw exceeds the reference voltage Vref2, the output of the current limiting comparator CMP2 becomes high and sets the RS flipflop FF2, the output Q of the RS flip-flop FF2 becomes high and resets the flipflop FF1, the output Q of the flipflop FF1 becomes low, thereby the drive switching element M1 turns off, and the rectifying switching element M2 turns on. Value of the inductor current IL herein is denoted as Imax.

In the conventional step-up DC-DC converter illustrated in FIG. 4, a fixed voltage has been used for the reference voltage Vref2 of the current limiting comparator CMP2. In contrast, in this embodiment, the reference voltage generation circuit 11 is provided, and the reference voltage Vref2 generated by the reference voltage generation circuit 11 is fed to the inverted input terminal of the current limiting comparator CMP2. Now, the reference voltage Vref2, which is the output of the reference voltage generation circuit (dividing circuit), is given by the formula below:

Vref2=A÷Vin formula (3)

where, A is a constant determined depending on conditions of use.

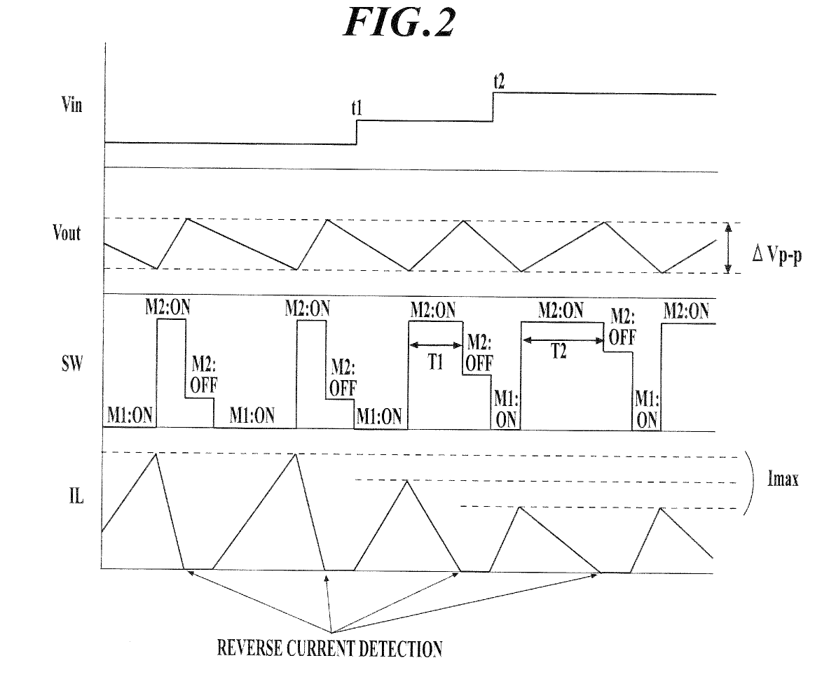

When the reference voltage Vref2 inversely proportional to the input voltage Vin is fed to the inverted input terminal of the current limiting comparator CMP2, the limiting current value Imax of the inductor current IL decreases as the input voltage Vin increases, as seen in the timing chart illustrated in FIG. 2. On the other hand, the limiting current value Imax increases as the input voltage Vin decreases. Making use of the increase and decrease in the limiting current value Imax, increase in the ripple ΔVp−p in the output associated with increase in the input voltage Vin may be suppressed.

Now, a specific procedure of setting of the limiting current value Imax will be explained. As has been discussed in the above, since the maximum current value Iout(MAX) possibly output by the DC-DC converter is determined by Imax, so that it is necessary to determine Imax so as to obtain a desired level of maximum current value Iout(MAX). Iout(MAX) is expressed by the aforementioned formula (2)

Iout(MAX)=(Vin×Imax×η)÷(2×Vout) formula (2)

Assuming, for example, that Vin=1V, Vout=5V, and η=0.8 in the formula (2), we obtain

Iout(MAX)=(1×Imax×0.8)÷(2×5)=0.08Imax.

Given that a desired Iout(MAX) is 0.5 A or larger,

Imax>6.25[A]

is obtained.

Note that the value of limiting current value Imax depends on the input voltage Vin, so that a necessary level of Iout(MAX) is also obtained by adjusting Imax corresponding to Vin.

For example, under the conditions described in the above, Imax is given as

Imax>6.25÷Vin formula (4)

Imax may be detected by the current limiting comparator CMP2 which compares the SW terminal voltage Vsw and the reference voltage Vref2 which is the output of the dividing circuit. Given that the ON resistance of the switching element M1 is 0.1Ω, the SW terminal voltage Vsw corresponded to Imax is expressed as:

Vsw=0.625÷Vin formula (5)

Under the conditions described in the above, and from the formulae (3), (4) and (5), an optimum Imax corresponded to a necessary level of Iout(MAX) may be obtained by setting the constant A=0.625 for the dividing circuit.

By adjusting the Imax corresponding to the value of Vin, the ripple ΔVp−p in the output may be reduced, ΔVp−p is now calculated by the formula (1):

ΔVp−p=(Imax²×L)÷(2×Cout×(Vout−Vin)) formula (1)

When Imax is set, for example, to ½ in the configuration described in the above, ΔVp−p may be reduced to ¼ of that in the prior art.

Referring now to the timing chart in FIG. 2, when the input voltage Vin elevates as seen at the times t1, t2, decrease in the inductor current IL moderates. When the input voltage Vin elevates, the reference voltage Vref2 however decreases, and the limiting current value Imax decreases. Accordingly, the time over which the switching element M1 turns on and current IL flows through the inductor becomes shorter. The output voltage Vout is therefore prevented from elevating, and the time from the switching element M2 turning off to the switching element M1 turning on, over which the output voltage Vout falls down to the reference voltage Vref1, becomes shorter. The ripple ΔVp−p in the output is reduced as a consequence.

As described in the above, the conventional step-up DC-DC converter based on the PFM control has been suffering from humming of the inductor or output capacitor, and malfunction of devices when ΔVp−p increased. In contrast, this embodiment successfully avoids the humming and malfunction of devices, while achieving a desired level of maximum output current value, by suppressing ΔVp−p to a low level.

This embodiment uses the reference voltage generation circuit 11 which generates the reference voltage Vref2 inversely proportional to the input voltage Vin. The reference voltage Vref2 is fed to the current limiting comparator CMP2, and the current limiting comparator CMP2 detects that the current IL which flows through the coil L1 reached a predetermined current value. Since the reference voltage Vref2 varies inversely proportional to the input voltage Vin, so that the output voltage Vout is prevented from elevating due to shortening of the time over which the inductor current IL flows, and thereby the ripple in the output may be reduced. In this way, the control circuit 10 may be configured in a relatively simple manner, without altering external components such as inductor or capacitor elements for smoothing the output.

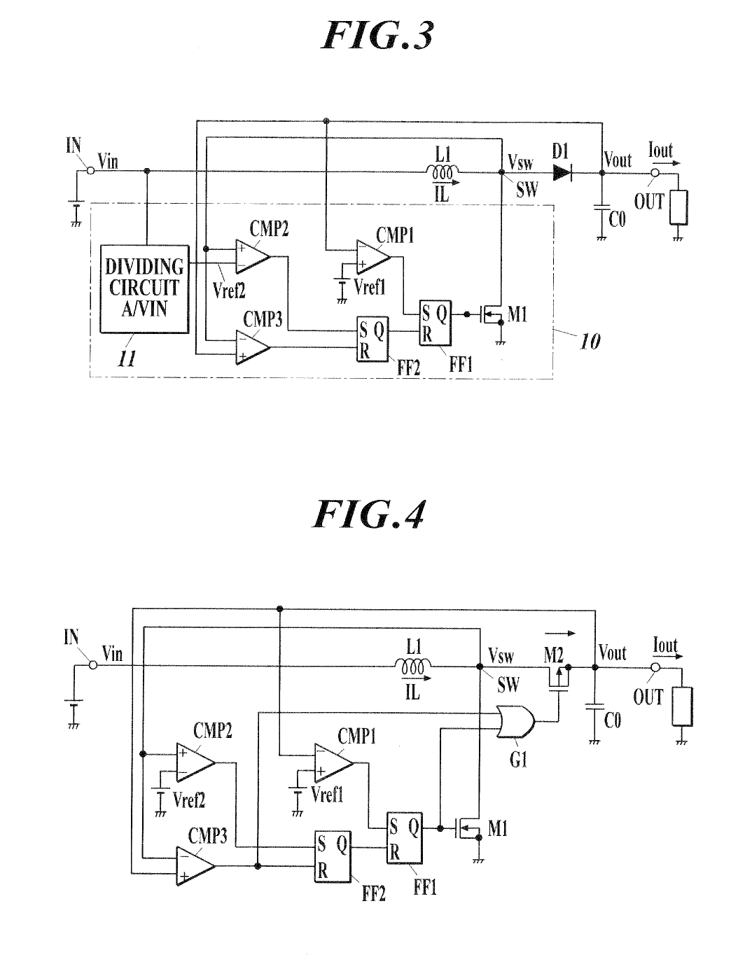

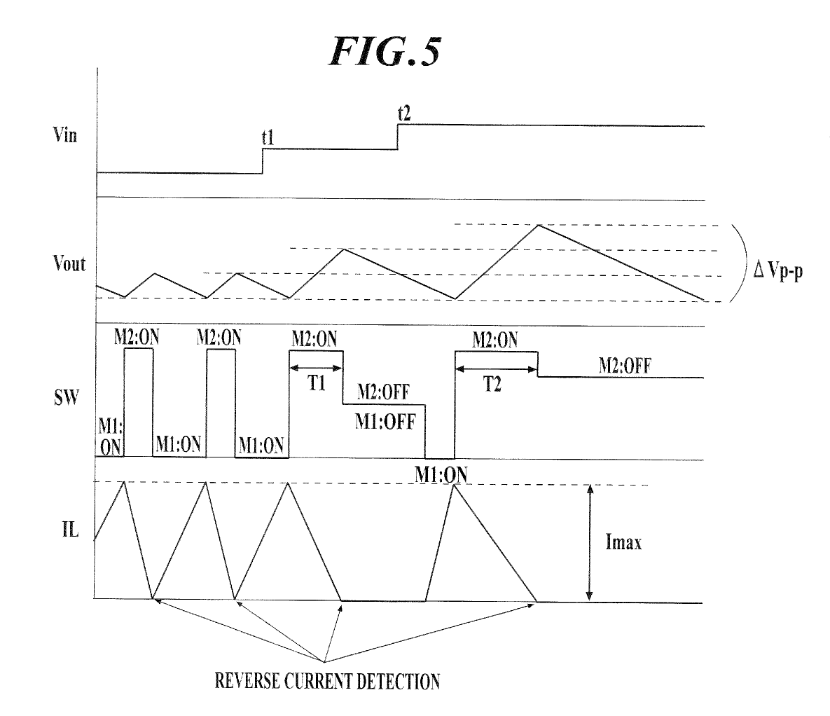

FIG. 3 illustrates a modified example of the DC-DC converter of this embodiment. In the modified example illustrated in FIG. 3, a diode D1 is used as the rectifier, in place of the switching element M2 used in the aforementioned embodiment.

In the modified example, the diode D1 turns on when the switching element M1 turns off, whereas the diode D1 turns off in the reverse current state which represents that the output voltage Vout becomes higher. By virtue of this configuration, the OR gate G1 for generating the ON/OFF control signal directed to the switching element M1 is now omissible, thereby the number of elements of the control circuit may be reduced, and an area needed for the circuit and the chip size may be reduced.

Having described the present invention referring to the preferred embodiments, it is to be understood that the embodiment is not restricted to the embodiments. For example, while the switching control circuit 10 in the embodiment was configured so that the current limiting comparator CMP2 compares the SW terminal voltage Vsw with the reference voltage Vref2 which is the output of the dividing circuit, another possible configuration is such as providing a sensing resistor for current-voltage conversion in series with the switching element M1, and allowing the current limiting comparator CMP2 to compare voltage obtained after conversion by the sensing resistor with the reference voltage Vref2.

It is to be understood that the embodiments disclosed herein are illustrative in all aspects but not restrictive. The scope of the present invention is defined by the appended claims rather than by the description in the above, and is therefore intended to embrace all changes that fall within metes and bounds of the claims, and equivalence thereof.

What is claimed is:

1. A step-up DC-DC converter comprising:
a voltage input terminal through which DC input voltage is input;
a voltage output terminal through which an output voltage stepped up from the input voltage is output;
an inductor having an input-side terminal connected to the voltage input terminal;
a drive switching element connected to an output-side terminal of the inductor;
a rectifier connected between the output-side terminal of the inductor and the voltage output terminal; and
a control circuit which generates a drive pulse used for ON/OFF control of the drive switching element, based on a feedback voltage received from the voltage output terminal and a voltage proportional to current flowing through the inductor,
the control circuit further comprising:
a first voltage comparator circuit which compares the feedback voltage received through the voltage output terminal, with a predetermined first reference voltage, and detects fall of the feedback voltage down to the first reference voltage;
a second voltage comparator circuit which compares a voltage proportional to current flowing through the inductor, with a second reference voltage, and detects rise of the voltage proportional to current flowing through the inductor up to the second reference voltage; and
a voltage generation circuit which generates a voltage inversely proportional to the input voltage and feeds the voltage, as the second reference voltage, to the second voltage comparator circuit,
wherein the step-up DC-DC converter is configured so that:
the drive switching element turns on when the first voltage comparator circuit detects that the feedback voltage fell down to the first reference voltage, and the drive switching element turns off when the second voltage comparator circuit detects that the voltage proportional to current flowing through the inductor rose up to the second reference voltage.

2. The step-up DC-DC converter of claim 1, further comprising a reverse current state detection circuit which compares voltage at the output-side terminal of the inductor, with voltage at the voltage output terminal, and detects a reverse current state which represents that the voltage at the output terminal is higher than the voltage at the output-side terminal of the inductor, and
the step-up DC-DC converter being configured so that:
the control circuit turns the rectifier off, when the reverse current state detection circuit detects the reverse current state.

3. The step-up DC-DC converter of claim 1, wherein the rectifier is a diode.

4. The step-up DC-DC converter of claim 2, wherein the voltage generation circuit is a dividing circuit which receives, as an input, the input voltage received through the voltage input terminal.

5. The step-up DC-DC converter of claim 1, wherein the voltage proportional to current flowing through the inductor is a voltage at the output-side terminal of the inductor.

6. The step-up DC-DC converter of claim 2, further comprising:
a first RS flipflop circuit which receives an output signal of the second voltage comparator circuit as a set signal, and receives an output signal of the reverse current state detection circuit as a reset signal;
a second RS flipflop circuit which receives an output signal of the first voltage comparator circuit as a set signal, and receives an output signal of the first RS flipflop circuit as a reset signal, to thereby generate a control signal for ON/OFF control of the drive switching element; and
an OR circuit which receives, as the input, an output signal of the second RS flipflop circuit and an output signal of the reverse current state detection circuit, and is configured to turn the rectifier on or off using an output signal thereof.
